(19) United States
(12) Patent Application Publication
(10) Pub. No.: US 2026/0262589 A1
(43) Pub. Date: Sep. 10, 2026

(54) CONDITION PRESENTATION APPARATUS, CONDITION PRESENTATION METHOD, AND NON-TRANSITORY COMPUTER READABLE MEDIUM

(71) Applicant: Yokogawa Electric Corporation, Tokyo (JP)

(72) Inventors: Emiko HATSUGAI, Tokyo (JP); Junshan WANG, Tokyo (JP); Hirari SATOU, Tokyo (JP)

(21) Appl. No.: 19/166,477

(22) PCT Filed: Feb. 27, 2024
(86) PCT No.: PCT/JP2024/007164

§ 371 Date: Sep. 18, 2025

(30) Foreign Application Priority Data
Mar. 24, 2023 (JP) 2023-047648

(51) Int. Cl. A01G 31/00; A01G 31/06; G06Q 30/0201; G06Q 50/02

(52) U.S. Cl. CPC A01G 31/011; A01G 31/06; G06Q 30/0206; G06Q 50/02

(57) ABSTRACT

A condition presentation apparatus may include a condition receiving unit which receives conditions of a harvest time and a yield to be satisfied for a plant that is cultivated in a plant factory. The condition presentation apparatus may include a presentation unit which presents at least one environmental control condition candidate that satisfies the conditions, together with a quality of the plant. The condition presentation apparatus may include a selection receiving unit which receives a selection of the environmental control condition to be used for the control of the environmental state by the environmental control equipment of the plant factory, from the at least one environmental control condition candidate.

### TECHNICAL FIELD

The contents of the following patent application(s) are incorporated herein by reference:
NO. 2023-047648 filed in JP on Mar. 24, 2023

The present invention relates to a condition presentation apparatus, a condition presentation method, and a program.

### BACKGROUND ART

Patent Document 1 discloses a cultivation method comprising the steps of: preparing correspondence information obtained by associating light characteristic information indicating the characteristics of light irradiating leafy vegetables with quantified quality information quantifying the quality of leafy vegetables; setting the optical characteristic information; and irradiating the leafy vegetables with light.

### Related Art Documents

### Patent Documents

Patent Document 1: Japanese Patent Application Publication No. 2022-13560

### GENERAL DISCLOSURE

### Technical Problem

When a plant is cultivated in a plant factory, a system that can take account of a quality of the plant, in addition to a harvest time and a yield of the plant, to select an appropriate environmental control condition, is desired.

### Solution to Problem

A condition presentation apparatus according to an aspect of the present invention may include a condition receiving unit which receives conditions of a harvest time and a yield to be satisfied for a plant that is cultivated in a plant factory. The plant may be a vegetable, a fruit, or a fresh flower. The plant may be at least one of the vegetable, the fruit, or the fresh flower. The plant may be a leaf lettuce. The condition receiving unit may receive, as a condition of the yield, a specified range of a weight of the plant, or a specified range of the number of boxes containing the plant. The condition presentation apparatus may include a presentation unit which presents at least one environmental control condition candidate that satisfies the conditions, together with a quality of the plant, based on environmental control condition information indicating an environmental control condition indicating a control condition of environmental control equipment that controls an environmental state in the plant factory, and a growth period and the yield of the plant, and the quality of the plant when the environmental control equipment controls the environmental state in the plant factory according to the environmental control condition. The condition presentation apparatus may include a selection receiving unit which receives a selection of the environmental control condition to be used for the control of the environmental state by the environmental control equipment of the plant factory, from the at least one environmental control condition candidate.

In the condition presentation apparatus, the condition receiving unit may further receive an allowable range of the quality to be satisfied for the plant. The presentation unit may present at least one environmental control condition candidate that satisfies the conditions of the harvest time and the yield, and the allowable range of the quality, together with the quality of the plant, based on the environmental control condition information. The condition receiving unit may receive a range of an index of the quality that is allowed, as the allowable range of the quality. The index of the quality may be a predetermined level according to a degree of the quality. The index of the quality may be at least one of a level of a size, a level of a taste, or a level of a shade of color.

In any of the condition presentation apparatuses, the environmental control condition may include a control condition of at least one of a temperature in the plant factory, or an amount of light of a light source that radiates light to the plant.

In any of the condition presentation apparatuses, the quality may indicate at least one index of a size, a taste, or a shade of color of the plant.

In any of the condition presentation apparatuses, before the condition receiving unit receives the condition, the presentation unit may present candidates for the harvest time and the yield of the plant, based on prediction information indicating at least one of a predicted market price of the plant or a predicted amount of demand of the plant. The presentation unit may present the candidates for the harvest time and the yield of the plant, based on the prediction information indicating a relationship between the harvest time of the plant and the predicted amount of demand of the plant. The prediction information may be information indicating a relationship between a daily predicted market price and a daily predicted amount of demand. The prediction information may be information indicating a relationship between a weekly predicted market price and a weekly predicted amount of demand. As the candidate for the harvest time of the plant, the presentation unit may determine a time point at which the predicted market price is the highest in a target period, based on the prediction information.

In any of the condition presentation apparatuses, the presentation unit may present the candidate for the yield obtained by multiplying a predetermined rate by the predicted amount of demand in the harvest time that is indicated by the prediction information. The predetermined rate may be determined in advance according to a market size of the plant and a maximum yield of the plant that is able to be cultivated in the plant factory. The presentation unit may acquire the prediction information from a prediction server which generates the prediction information, by using a learning model that predicts a market price and an amount of demand of the plant in future from a market price and an amount of demand in past. The prediction server may use a learning model for each type of the plant to predict the predicted market price and the predicted amount of demand for each type of the plant. The prediction server may set weather information for each predetermined period and event information for each predetermined period, as explanatory variables, and set the market price and the predicted amount of demand, as objective variables, and perform machine learning according to a supervised learning algorithm, thereby generating a trained prediction model as the learning model. The prediction server may set daily weather information and daily event information, as the explanatory variables, and set the market price and the predicted amount of demand, as the objective variables, and perform machine learning according to a supervised learning algorithm, thereby generating a trained prediction model as the learning model.

Any of the condition presentation apparatuses may further include an environmental control condition providing unit which provides the selected environmental control condition to an environmental control apparatus which controls the environmental control equipment that adjusts an environment of the plant factory. The environmental control condition may include at least one of a condition for controlling, in order to set the growth period to be shorter or longer than a reference growth period, air conditioning equipment of the plant factory such that a temperature is higher or lower than that during the reference growth period, or a condition for controlling, in order to set the growth period to be shorter or longer than the reference growth period, light source equipment of the plant factory such that an amount of light of the plant factory is greater or smaller than that during the reference growth period. The environmental control condition may include the condition for controlling, in order to set the growth period to be shorter than the reference growth period, the air conditioning equipment such that the temperature is higher than that during the reference growth period. The environmental control condition may include the condition for controlling, in order to set the growth period to be longer than the reference growth period, the air conditioning equipment such that the temperature is lower than that during the reference growth period. The environmental control condition may include the control condition of at least one of the air conditioner or the blower fan included in the air conditioning equipment. The air conditioner may have a heat pump. The environmental control condition may include the condition for controlling, in order to set the growth period to be shorter than the reference growth period, the light source equipment such that the amount of light is greater than that during the reference growth period. The environmental control condition may include the condition for controlling, in order to set the growth period to be longer than the reference growth period, the light source equipment such that the amount of light is smaller than that during the reference growth period. The environmental control conditions may include the control condition for electric power, a current, or a voltage that is supplied to a dimmer included in the light source equipment.

A condition presentation method according to an aspect of the present invention may include receiving, by a condition receiving unit, conditions of a harvest time and a yield to be satisfied for a plant that is cultivated in a plant factory. The condition presentation method may include presenting, by a presentation unit, at least one environmental control condition candidate that satisfies the conditions, together with a quality of the plant, based on environmental control condition information indicating an environmental control condition indicating a control condition of environmental control equipment that controls an environmental state in the plant factory, and a growth period and the yield of the plant, and the quality of the plant when the environmental control equipment controls the environmental state in the plant factory according to the environmental control condition. The condition presentation method may include receiving, by a selection receiving unit, a selection of the environmental control condition to be used for the control of the environmental state by the environmental control equipment of the plant factory, from the at least one environmental control condition candidate.

A program according to an aspect of the present invention may cause a computer to execute receiving conditions of a harvest time and a yield to be satisfied for a plant that is cultivated in a plant factory. The program may cause the computer to execute presenting at least one environmental control condition candidate that satisfies the conditions, together with a quality of the plant, based on environmental control condition information indicating an environmental control condition indicating a control condition of environmental control equipment that controls an environmental state in the plant factory, and a growth period and the yield of the plant, and the quality of the plant when the environmental control equipment controls the environmental state in the plant factory according to the environmental control condition. The program may cause the computer to execute receiving a selection of the environmental control condition to be used for the control of the environmental state by the environmental control equipment of the plant factory, from the at least one environmental control condition candidate.

The summary clause does not necessarily describe all necessary features of the embodiments of the present invention. The present invention may also be a sub-combination of the features described above.

### BRIEF DESCRIPTION OF DRAWINGS

FIG. 1 is a diagram showing an example of a functional block of an overall configuration of a plant management system according to the present embodiment.

FIG. 2 is a diagram showing an example of a functional block of a condition presentation apparatus.

FIG. 3 is a diagram showing an example of prediction information showing a relationship between a predicted market price and a predicted amount of demand of a plant.

FIG. 4 is a diagram showing an example of environmental control condition information.

FIG. 5 is a flowchart showing an example of a procedure in which the condition presentation apparatus provides an environmental control condition to a plant management apparatus.

FIG. 6 is a diagram showing an example of a hardware configuration.

### DESCRIPTION OF EXEMPLARY EMBODIMENTS

Hereinafter, the present invention will be described through embodiments of the invention, but the following embodiments do not limit the invention according to claims. In addition, not all of the combinations of features described in the embodiments are essential to the solution of the invention.

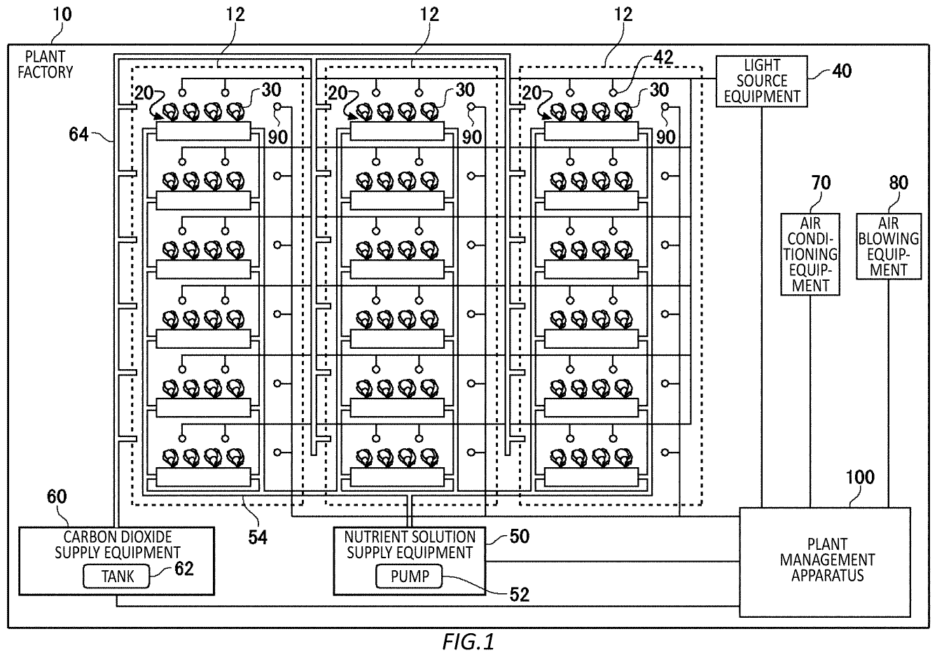

FIG. 1 is a diagram showing an example of a functional block of an overall configuration of a plant management system according to the present embodiment. The plant management system manages a growth state of a plant 30 that is cultivated in a plant factory 10. The plant management system includes a plurality of cultivation racks 20, light source equipment 40, nutrient solution supply equipment 50, carbon dioxide supply equipment 60, air conditioning equipment 70, air blowing equipment 80, a sensor 90, and a plant management apparatus 100. The plant management system further includes a condition presentation apparatus 200 which provides an environmental control condition to the plant management apparatus 100. The plant management apparatus 100 is an example of an environmental control apparatus. The light source equipment 40, the nutrient solution supply equipment 50, the carbon dioxide supply equipment 60, the air conditioning equipment 70, and the air blowing equipment 80 are examples of environmental control equipment.

The cultivation rack 20 cultivates the plant 30 such as a vegetable, a fruit, or a fresh flower. By shifting a sowing date for each set of one or more cultivation racks 20, adjustments are performed such that the plants 30 can be harvested at harvest times different from each other. In addition, by each of the one or more cultivation racks 20 being installed in a separate space 12 for the plurality of cultivation racks 20, and by an environment in the space 12 being individually controlled by the environmental control equipment according to the environmental control condition, the plant 30 may be cultivated in a different environmental state for each space 12. The space 12 may be a space in which heat insulation and airtightness are high. The environmental control condition indicates a control condition for controlling an operation of each environmental control equipment. It should be noted that in the present embodiment, the plant management apparatus 100 individually controls the environmental state for each set of the cultivation racks 20. However, the plant management apparatus 100 may individually control the environmental state of each of a plurality of shelves included in one cultivation rack 20.

The light source equipment 40 includes a plurality of light sources 42 such as LEDs or incandescent lamps that radiate artificial light, and radiates the artificial light to the plant 30 from each of the plurality of light sources 42. The plurality of light sources 42 may be arranged to face a cultivation surface of the cultivation rack 20.

The nutrient solution supply equipment 50 has a pump 52 and a pipe 54, and supplies, to the cultivation rack 20 via the pump 52 and the pipe 54, a nutrient solution containing each of fertilizer components such as potassium or calcium. The nutrient solution supply equipment 50 appropriately adjusts a fertilizer concentration, and supplies, to the plant 30, the nutrient solution with the adjusted fertilizer concentration. The nutrient solution supply equipment 50 may supply the nutrient solution to the plant 30 by atomizing the nutrient solution with the adjusted fertilizer concentration and spraying the atomized nutrient solution onto a root part of the plant 30. The nutrient solution supply equipment 50 may function as irrigation equipment that supplies water to a medium in which the plant 30 is cultivated. An amount of irrigation that is supplied to the cultivation rack 20 may be adjusted by adjusting an amount of the nutrient solution that is supplied to the cultivation rack 20 from the nutrient solution supply equipment 50.

The carbon dioxide supply equipment 60 has a tank 62 and a nozzle 64. The tank 62 stores carbon dioxide. The carbon dioxide supply equipment 60 supplies carbon dioxide stored in the tank 62, to each space 12 in the plant factory 10 via the nozzle 64.

The air conditioning equipment 70 controls a temperature and humidity of an air in the plant factory 10, and circulates the air of which the temperature and the humidity are controlled, into each space. The air blowing equipment 80 includes a circulator or a fan that supplies a wind into the plant factory 10. The sensor 90 includes various types of sensors that measure the environmental state around the plant 30 and the growth state of the plant 30. The sensor 90 includes various types of sensors that respectively measure the temperature, the humidity, an amount of light, and a carbon dioxide concentration of stem, leaf, and fruit portions of the plant 30.

The plant management apparatus 100 controls the growth state of the plant 30 by controlling the light source equipment 40, the nutrient solution supply equipment 50, the carbon dioxide supply equipment 60, the air conditioning equipment 70, and the air blowing equipment 80, according to the environmental control condition. The plant management apparatus 100 communicates with the light source equipment 40, the nutrient solution supply equipment 50, the carbon dioxide supply equipment 60, the air conditioning equipment 70, and the air blowing equipment 80, via a wireless network or a wired network. The condition presentation apparatus 200 communicates with the plant management apparatus 100 via the wireless network or the wired network.

The plant management apparatus 100 and the condition presentation apparatus 200 may be computers having central processing units (CPU) and memories. The light source equipment 40, the nutrient solution supply equipment 50, the carbon dioxide supply equipment 60, the air conditioning equipment 70, and the air blowing equipment 80 may include the computers having the central processing units (CPU) and the memories.

The computer may be a computer such as a personal computer, a tablet type computer, a smartphone, a workstation, a server computer, or a general purpose computer, or may be a computer system in which a plurality of computers are connected. Such a computer system is also a computer in a broad sense. The computer may be a dedicated computer designed for an environmental control of a plant factory, or may be dedicated hardware realized by dedicated circuitry. The computer may be implemented by a virtual computer environment. When the computer is used, the plant management apparatus 100, the condition presentation apparatus 200, the light source equipment 40, the nutrient solution supply equipment 50, the carbon dioxide supply equipment 60, the air conditioning equipment 70, and the air blowing equipment 80 are realized by executing a program by the computer.

In the plant management system configured as described above, the condition presentation apparatus 200 presents environmental control conditions that satisfy a harvest time and a yield of a plant, together with a quality of the plant, and causes a user to select the optimal environmental control condition.

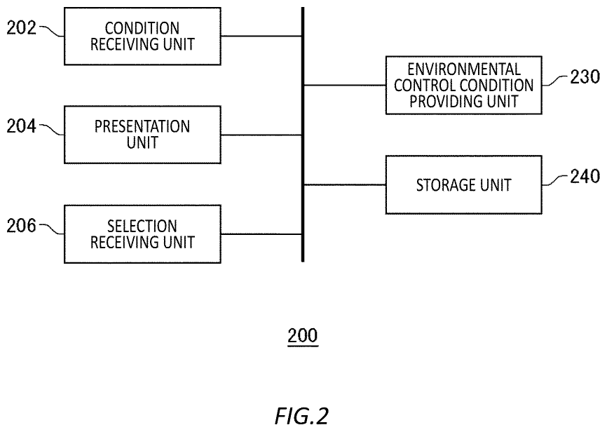

FIG. 2 is a diagram showing an example of a functional block of the condition presentation apparatus 200. The condition presentation apparatus 200 includes a condition receiving unit 202, a presentation unit 204, a selection receiving unit 206, an environmental control condition providing unit 230, and a storage unit 240.

The condition receiving unit 202 receives the conditions of the harvest time and the yield to be satisfied for the plant 30 that is cultivated in the plant factory 10. The condition receiving unit 202 may receive the conditions of the harvest time and the yield to be satisfied for the plant 30 from a person in charge of adjusting the harvest time and the yield of the plant 30. As the condition for the harvest time of the plant 30, the condition receiving unit 202 may receive a specific period having a specific length, such as specific one day, specific three days, or specific five days. In addition, as the yield of the plant 30, the condition receiving unit 202 may receive a specified range of a weight or a number, the range having a certain width in tons, the number of boxes, the number of plants, or the like.

When the plant 30 is a vegetable, a fruit, a fresh flower, or the like that is bought and sold in a market, a market price fluctuates by the harvest time. When the harvest time and the yield is determined, in a case where it is possible to take account of predicted results of the market price and an amount of demand, it will be more convenient for the person in charge.

Therefore, before the condition receiving unit 202 receives the conditions for the harvest time and the yield of the plant 30, the presentation unit 204 may present candidates for the harvest time and the yield of the plant 30, based on prediction information indicating a relationship between a predicted market price of the plant 30 and a predicted amount of demand of the plant 30.

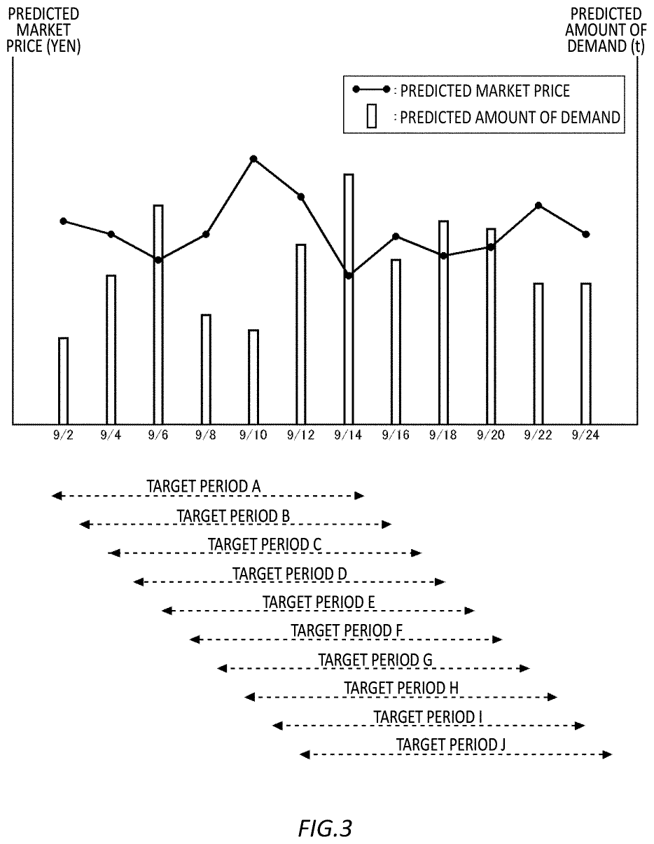

The prediction information may be, for example, information indicating a relationship between a daily predicted market price (yen) and a daily predicted amount of demand (t), as shown in FIG. 3. The prediction information may be information indicating a relationship between a weekly predicted market price (yen) and a weekly predicted amount of demand (t). The prediction information may be information indicating a relationship between a predicted market price (yen) and a predicted amount of demand (t) for each predetermined period other than a day or a week.

As the candidate for the harvest time of the plant 30, the presentation unit 204 may determine a time point at which the predicted market price is the highest in a target period. To the target period, at least one set of cultivation racks 20 in which sowing dates are the same as each other is allocated. The set of cultivation racks 20 may include a plurality of cultivation racks 20 having the same sowing date. The set of cultivation racks 20 may include a plurality of cultivation racks 20 having the same sowing date and existing in the space 12 in which it is possible to individually control the environmental state. For example, as the candidate for the harvest time of the plant 30 for a target period A to a target period H, the presentation unit 204 may determine “September 10th” at which the predicted market price is the highest. As the candidate for the harvest time of the plant 30 for a target period I to a target period J, the presentation unit 204 may determine “September 12th”.

The presentation unit 204 may further determine the candidate for the yield of the plant, in the candidates for the harvest time for the plant 30, based on the prediction information. The presentation unit 204 may determine a yield S of the plant 30 by multiplying a predetermined rate by the predicted amount of demand in the candidate for the harvest time of the plant 30 that is indicated by the prediction information. The predetermined rate may be determined in advance according to a market size of the plant 30 and a maximum yield of the plant 30 that is able to be cultivated in the plant factory 10. The presentation unit 204 may further determine the number of sets of cultivation racks 20 serving as targets on which the plants 30 are cultivated during the harvest time, so as to satisfy the yield S. The yield S of the plant 30 per set of cultivation racks 20 may be determined in advance from an actual measurement value, to be stored in the storage unit 120.

The presentation unit 204 may acquire the prediction information from a prediction server which generates the prediction information, by using a learning model that predicts the market price and the amount of demand of the plant 30 in the future from the market price and the amount of demand in the past. The prediction server may use a learning model for each type of the plant 30 to predict the predicted market price and the predicted amount of demand for each type of the plant 30. For example, the prediction server may set daily weather information, event information of an event or the like, and the like, as explanatory variables, and set the market price and the amount of demand, as objective variables, and perform machine learning according to a supervised learning algorithm, thereby generating a trained prediction model. The algorithm may be an algorithm of any scheme, such as a neural network, a support vector machine, a multiple regression analysis, or a decision tree. The presentation unit 204 may acquire the prediction information from a server which is provided by an organization that provides the prediction information of the market price and the amount of demand.

The presentation unit 204 presents at least one environmental control condition candidate that satisfies the conditions of the harvest time and the yield condition received by the condition receiving unit 202, together with the quality of the plant 30, based on environmental control condition information indicating the environmental control condition indicating the control condition of the environmental control equipment that controls the environmental state in the plant factory 10, and a growth period and the yield of the plant 30, and the quality of the plant 30 when the environmental control equipment controls the environmental state in the plant factory 10 according to the environmental control condition. The environmental control condition indicates the control condition of the environmental control equipment during the growth period of the plant 30. The environmental control condition may include the control condition of at least one of the temperature in the plant factory 10, or the amount of light of the light source 42 that radiates the light to the plant 30. The environmental control condition may indicate an hourly set condition of the temperature in the plant factory 10, and an hourly set condition of the light source 42 during the growth period of the plant 30.

The quality of the plant 30 may be at least one index indicating the state of the plant 30. The quality of the plant 30 may indicate, for example, at least one of a size, a taste, or a shade of color of the plant 30.

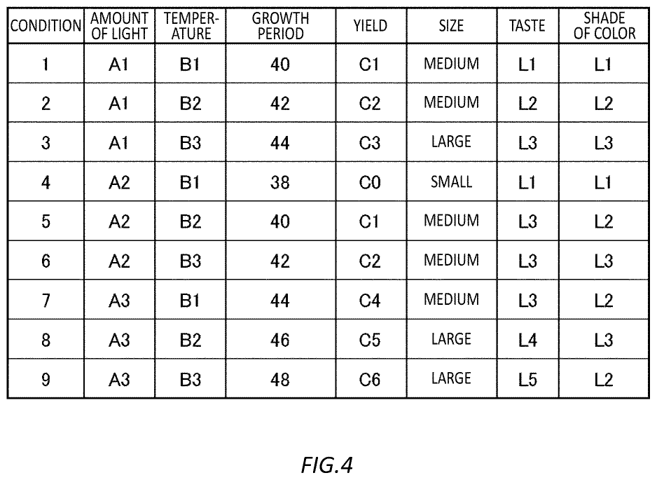

The environmental control condition information may be, for example, information as shown in FIG. 4. That is, the environmental control condition information may indicate a condition of the amount of light of the light source 42, a condition of the temperature, and the growth period, the yield, the size, the taste, and the shade of color of the plant 30, for each environmental control condition. The condition of the amount of light of the light source 42 may indicate the condition of the amount of light for each stage obtained by dividing the growth period into a plurality of stages. The condition of the temperature may indicate the condition of the temperature for each stage of the growth period. The size may indicate the size of the plant 30, for example, by indexes of three levels. The taste may indicate a degree of taste of the plant 30, for example, in five levels. The shade of color may indicate a degree of the shade of color of the plant 30 in three levels. Each index of the quality is not limited to the above, and may be appropriately set according to the type of the plant 30 and the like.

The environmental control condition information may be generated by changing the environmental control condition for each stage of the growth period and actually cultivating the plant 30 in the plant factory 10, and by evaluating a cultivation result thereof; and be stored in the storage unit 240.

The selection receiving unit 206 receives a selection of the environmental control condition to be used for the environmental control of the plant factory 10, from the at least one environmental control condition candidate. Since the at least one environmental control condition candidate that satisfies the conditions of the harvest time and the yield received by the condition receiving unit 202 is presented together with the quality of the plant 30, the person in charge only needs to select, from the at least one environmental control condition candidate, the environmental control condition that satisfies the desired quality.

The condition receiving unit 202 may further receive an allowable range of the quality to be satisfied for the plant 30. The condition receiving unit 202 may receive a range of the index of the quality that is allowed, as the allowable range of the quality. For example, the condition receiving unit 202 may receive the allowable range of the size such as only “large”, or only “large” and “medium” as the size. The condition receiving unit 202 may receive the range that is allowed between a level L1 and a level L5 (the level L1 is a lowest level of the taste, and the level L5 is a highest level of the taste), as the allowable range of the taste. The condition receiving unit 202 may receive the range that is allowed between a level L1 and a level L3 (the level L1 is a lowest level of the shade of color, and the level L3 is a highest level of the shade of color), as the allowable range of the shade of color. The presentation unit 204 may present at least one environmental control condition candidate that satisfies the conditions of the harvest time and the yield, and the allowable range of the quality, together with the quality of the plant 30, based on the environmental control condition information. The person in charge only needs to select the environmental control condition that satisfies the quality that better meets the desire, from at least the one environmental control condition candidate that satisfies the allowable range of the quality.

The environmental control condition providing unit 230 provides the selected environmental control condition to the plant management apparatus 100 which controls the environmental control equipment that adjusts the environment of the plant factory 10. According to the environmental control condition from the condition presentation apparatus 200, the plant management apparatus 100 controls at least one of the light source equipment 40, the nutrient solution supply equipment 50, the carbon dioxide supply equipment 60, the air conditioning equipment 70, or the air blowing equipment 80; and cultivate the plant 30 to be able to obtain the desired harvest time and the desired yield. According to the environmental control condition from the condition presentation apparatus 200, the plant management apparatus 100 may control the light source equipment 40 to control the amount of light of the light source 42, and control the air conditioning equipment 70 to control the temperature in the plant factory 10. The environmental control condition may include at least one of: a condition for controlling, in order to set the growth period to be shorter or longer than a reference growth period, the air conditioning equipment 70 of the plant factory 10 such that the temperature is higher or lower than that during the reference growth period; or a condition for controlling, in order to set the growth period to be shorter or longer than the reference growth period, the light source equipment 40 of the plant factory 10 such that the amount of light of the plant factory 10 is greater or smaller than that during the reference growth period. The environmental control condition may include the condition for controlling, in order to set the growth period to be shorter than the reference growth period, the air conditioning equipment 70 such that the temperature is higher than that during the reference growth period. The environmental control condition may include the condition for controlling, in order to set the growth period to be longer than the reference growth period, the air conditioning equipment 70 such that the temperature is lower than that during the reference growth period. The environmental control condition may include the control condition of electric power, a current, or a voltage that is supplied to at least one of the air conditioner or the blower fan included in the air conditioning equipment 70. The air conditioner has a heat pump. The environmental control condition may include the condition for controlling, in order to set the growth period to be shorter than the reference growth period, the light source equipment 40 such that the amount of light is greater than that during the reference growth period. The environmental control condition may include the condition for controlling, in order to set the growth period to be longer than the reference growth period, the light source equipment 40 such that the amount of light is smaller than that during the reference growth period. The environmental control conditions may include the control condition for the electric power, the current, or the voltage that is supplied to a dimmer included in the light source equipment 40.

For example, when the plant 30 is a variety such as a leaf lettuce, the plant management apparatus 100 may control, in order to set the growth period to be shorter than the reference growth period, the air conditioning equipment 70 such that the temperature is higher than that during the reference growth period, according to the environmental control condition. The plant management apparatus 100 may control, in order to set the growth period for the plant 30 to be longer than the reference growth period, the air conditioning equipment 70 such that the temperature is lower than that during the reference growth period, according to the environmental control condition.

Alternatively, the plant management apparatus 100 may control, in order to set the growth period to be shorter than the reference growth period, the light source equipment 40 such that the amount of light is greater than that during the reference growth period, according to the environmental control condition. The plant management apparatus 100 may control, in order to set the growth period to be longer than the reference growth period, the light source equipment 40 such that the amount of light is smaller than that during the reference growth period, according to the environmental control condition.

The plant management apparatus 100 may adjust the yield of the plant 30 by adjusting the number of cultivation racks 20 which is a control target. The environmental control condition information may indicate the number of cultivation racks 20 which is the control target in accordance with the yield of the plant 30.

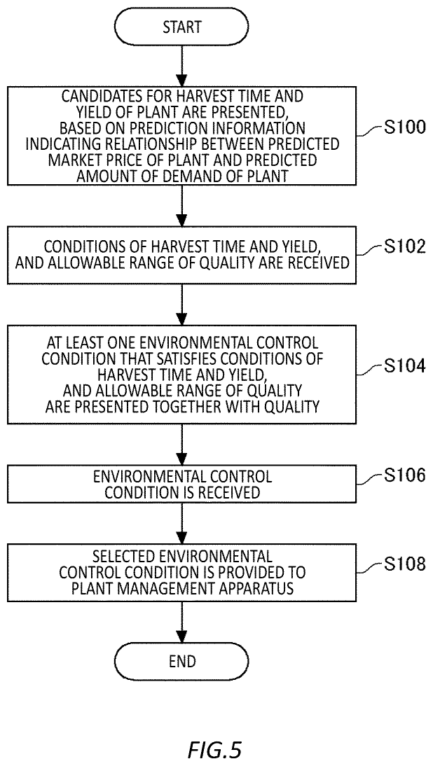

FIG. 5 is a flowchart showing an example of a procedure in which the condition presentation apparatus 200 provides an environmental control condition to the plant management apparatus 100.

Therefore, the presentation unit 204 determines the candidates for the harvest time and the yield of the plant 30 in the target period, based on the prediction information indicating the relationship between the predicted market price of the plant and the predicted amount of demand of the plant; and presents, on a display or the like, the determined candidates for the harvest time and the yield of the plant 30 (S100).

The condition receiving unit 202 receives the conditions of the harvest time and the yield to be satisfied for the plant 30 that is cultivated in the plant factory 10, and the allowable range of the quality to be satisfied for the plant 30 (S102). The condition receiving unit 202 may receive the conditions of the harvest time and the yield from among the candidates for the harvest time and the yield of the plant 30 in the target period.

The presentation unit 204 may present, on the display or the like, at least one environmental control condition candidate that satisfies the conditions of the harvest time and the yield, and the allowable range of the quality, together with the quality of the plant 30, based on the environmental control condition information (S104).

The selection receiving unit 206 receives a selection of the environmental control condition to be used for the environmental control of the plant factory 10, from the at least one environmental control condition candidate (S106). The environmental control condition providing unit 230 provides the selected environmental control condition to the plant management apparatus 100 which controls the environmental control equipment that adjusts the environment of the plant factory 10 (S108).

As described above, with the condition presentation apparatus 200 according to the present embodiment, the environmental control conditions that satisfy the harvest time and the yield of the plant are presented together with the quality of the plant; the user is caused to select the optimal environmental control condition; and according to the selected environmental control condition, it is possible to control the environment of the plant factory 10. In this manner, the plant factory 10 can cultivate the plant 30 to satisfy the desired harvest time and yield while taking account of the quality of the plant, as well.

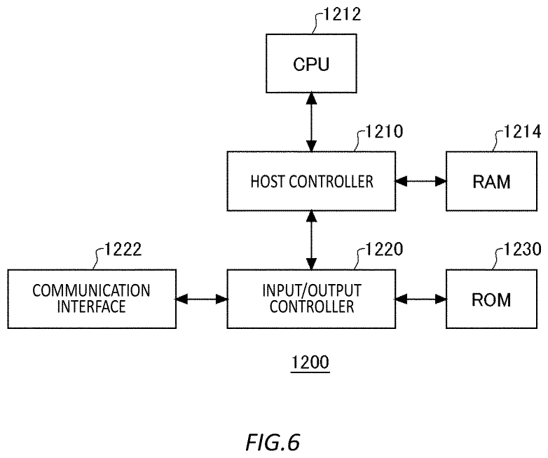

FIG. 6 shows an example of a computer 1200 in which an aspect of the present embodiment may be entirely or partially embodied. Programs installed in the computer 1200 can cause the computer 1200 to function as operations associated with the apparatus according to the embodiments of the present invention or one or more “units” of the apparatus. Alternatively, the programs can cause the computer 1200 to execute the operations or the one or more “units”. The programs can cause the computer 1200 to execute a process according to the embodiments of the present invention or steps of the process. Such programs may be executed by a CPU 1212 to cause the computer 1200 to perform specific operations associated with some or all of the blocks in the flowcharts and block diagrams described in the present specification.

The computer 1200 according to the present embodiment includes the CPU 1212 and a RAM 1214, which are mutually connected by a host controller 1210. The computer 1200 also includes a communication interface 1222 and an input/output unit, which are connected to the host controller 1210 via an input/output controller 1220. The computer 1200 also includes a ROM 1230. The CPU 1212 operates according to the programs stored in the ROM 1230 and the RAM 1214, thereby controlling each unit.

The communication interface 1222 communicates with other electronic devices via a network. A hard disk drive may store the programs and data used by the CPU 1212 in the computer 1200. The ROM 1230 stores therein boot programs or the like executed by the computer 1200 at the time of activation, and/or stores programs depending on hardware of the computer 1200. The programs are provided via a computer readable storage medium such as CR-ROM, a USB memory or an IC Card, or a network. The programs are installed on the RAM 1214, which also is an example of the computer readable storage medium, or the ROM 1230 and performed by the CPU 1212. Information processing written in these programs is read by the computer 1200, and provides cooperation between the programs and the various types of hardware resources described above. An apparatus or a method may be configured by implementing operations or processing of information according to a use of the computer 1200.

For example, in a case where a communication is performed between the computer 1200 and an external device, the CPU 1212 may execute a communication program loaded in the RAM 1214 and instruct the communication interface 1222 to perform communication processing based on a process written in the communication program. Under the control of the CPU 1212, the communication interface 1222 reads transmission data which is stored in the RAM 1214 or a transmission buffer region which is provided in a storage media such as a USB memory, to transmit the read transmission data to the network or write the reception data received from the network into a reception buffer region or the like provided on the storage media.

Also, the CPU 1212 may cause the whole or required part of files which are stored in the external storage media (such as USB memory) or the database to be read by the RAM 1214, to perform a various type of processes for the data on the RAM 1214. Then, the CPU 1212 may write back the processed data to the external storage media.

A various type of information such as a various type of programs, data, tables and databases may be stored in a storage media to undergo information processing. The CPU 1212 may execute, on the data read from the RAM 1214, various types of processing including various types of operations, information processing, conditional judgement, conditional branching, unconditional branching, information retrieval/replacement, or the like described throughout the present disclosure and specified by instruction sequences of the programs, to write the results back to the RAM 1214. Also, the CPU 1212 may retrieve information in the file, database, or the like in the storage media. For example, when a plurality of entries each having an attribute value of the first attribute associated with an attribute value of the second attribute are stored in a storage media, the CPU 1212 may retrieve, among the plurality of entries, an entry whose attribute value of the first attribute is specified and matches the conditions and read the attribute value of the second attribute stored in the entry, thereby acquiring the attribute value of the second attribute associated with the first attribute which satisfies a predetermined condition.

The programs or software module described above may be stored on the computer 1200 or in a computer readable storage medium near the computer 1200. In addition, a storage medium such as a hard disk or a RAM provided in a server system connected to a dedicated communication network or the Internet can be used as a computer readable storage media, thereby providing the program to the computer 1200 via the network.

A computer readable medium may include any tangible device that can store instructions to be executed by a suitable device. As a result, the computer readable medium having instructions stored therein includes an article of manufacture including instructions which can be executed to create means for performing operations specified in the flowcharts or block diagrams. Examples of the computer readable medium may include an electronic storage medium, a magnetic storage medium, an optical storage medium, an electromagnetic storage medium, a semiconductor storage medium, and the like. Specific examples of the computer readable medium may include a floppy (registered trademark) disk, a diskette, a hard disk, a random access memory (RAM), a read-only memory (ROM), an erasable programmable read-only memory (EPROM or Flash memory), an electrically erasable programmable read-only memory (EEPROM (registered trademark)), a static random access memory (SRAM), a portable compact disc read-only memory (CD-ROM), a digital versatile disc (DVD), a Blu-ray (registered trademark) disc, a memory stick, an integrated circuit card, or the like.

The computer readable instructions may include either source code or object code written in any combination of one or more programming languages. The source code or the object code includes a conventional procedural programming language. The conventional procedural programming language may be assembler instructions, instruction-set-architecture (ISA) instructions, machine instructions, machine dependent instructions, microcode, firmware instructions, state-setting data, or an object oriented programming language such as Smalltalk (registered trademark), JAVA (registered trademark), C++, etc., and programming languages, such as the “C” programming language or similar programming languages. The computer readable instructions may be provided to a processor of a general purpose computer, special purpose computer, or other programmable data processing device, or to programmable circuitry, locally or via a local area network (LAN), a wide area network (WAN) such as the Internet, etc. The processor or the programmable circuitry may execute the computer readable instructions in order to create means for performing operations specified in the flowcharts or block diagrams. Examples of the processor include a computer processor, a processing unit, a microprocessor, a digital signal processor, a controller, a microcontroller, and the like.

While the present invention has been described by way of the embodiments, the technical scope of the present invention is not limited to the above described embodiments. It is apparent to persons skilled in the art that various alterations or improvements can be made to the above described embodiments. It is also apparent from the description of the claims that embodiments added with such alterations or improvements can be included in the technical scope of the present invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCE NUMBERS

10: plant factory;
20 cultivation rack;
30: plant;
40: light source equipment;
42: light source;
50: nutrient solution supply equipment;
52: pump;
54: pipe;
60: carbon dioxide supply equipment;
62: tank;
64: nozzle;
70: air conditioning equipment;
80: air blowing equipment;
90: sensor;
100: plant management apparatus;
200: condition presentation apparatus;
202: condition receiving unit;
204: presentation unit;
206: selection receiving unit;
230: environmental control condition providing unit;
240: storage unit;
1200: computer;
1210: host controller;
1212: CPU;
1214: RAM;
1220: input/output controller;
1222: communication interface;
1230: ROM.

1. A condition presentation apparatus comprising a processor, wherein the processor:
receives conditions of a harvest time and a yield to be satisfied for a plant that is cultivated in a plant factory;
presents at least one environmental control condition candidate that satisfies the conditions, together with a quality of the plant, based on environmental control condition information indicating an environmental control condition indicating a control condition of environmental control equipment that controls an environmental state in the plant factory, and a growth period and the yield of the plant, and the quality of the plant when the environmental control equipment controls the environmental state in the plant factory according to the environmental control condition; and
receives a selection of the environmental control condition to be used for the control of the environmental state by the environmental control equipment of the plant factory, from the at least one environmental control condition candidate.

2. The condition presentation apparatus according to claim 1, wherein
the processor further receives an allowable range of the quality to be satisfied for the plant, and
the processor presents at least one environmental control condition candidate that satisfies the conditions of the harvest time and the yield, and the allowable range of the quality, together with the quality of the plant, based on the environmental control condition information.

3. The condition presentation apparatus according to claim 1, wherein the environmental control condition includes a control condition of at least one of a temperature in the plant factory, or an amount of light of a light source that radiates light to the plant.

4. The condition presentation apparatus according to claim 1, wherein the quality indicates at least one index of a size, a taste, or a shade of color of the plant.

5. The condition presentation apparatus according to claim 1, wherein the processor receives, as a condition of the yield, a specified range of a weight of the plant, or a specified range of the number of boxes containing the plant.

6. The condition presentation apparatus according to claim 1, wherein
before receiving the condition, the processor presents candidates for the harvest time and the yield of the plant, based on prediction information indicating at least one of a predicted market price of the plant or a predicted amount of demand of the plant.

7. The condition presentation apparatus according to claim 6, wherein the processor presents the candidates for the harvest time and the yield of the plant, based on the prediction information indicating a relationship between the harvest time of the plant and the predicted amount of demand of the plant.

8. The condition presentation apparatus according to claim 6, wherein the processor acquires the prediction information from a prediction server which generates the prediction information, by using a learning model that predicts a market price and an amount of demand of the plant in future from a market price and an amount of demand in past, and presents the candidates for the harvest time and the yield of the plant based on the acquired prediction information.

9. The condition presentation apparatus according to claim 8, wherein the prediction server sets weather information for each predetermined period and event information for each predetermined period, as explanatory variables, and sets the market price and the predicted amount of demand, as objective variables, and performs machine learning according to a supervised learning algorithm, thereby generating a trained prediction model as the learning model.

10. The condition presentation apparatus according to claim 6, wherein the processor presents the candidate for the yield obtained by multiplying a predetermined rate by the predicted amount of demand in the harvest time that is indicated by the prediction information.

11. The condition presentation apparatus according to claim 6, wherein as the candidate for the harvest time of the plant, the processor determines a time point at which the predicted market price is the highest in a target period, based on the prediction information.

12. The condition presentation apparatus according to claim 1, wherein the processor provides the selected environmental control condition to an environmental control apparatus which controls the environmental control equipment that adjusts an environment of the plant factory.

13. The condition presentation apparatus according to claim 12, wherein the environmental control condition includes at least one of
a condition for controlling, in order to set the growth period to be shorter or longer than a reference growth period, air conditioning equipment of the plant factory such that a temperature is higher or lower than that during the reference growth period, or
a condition for controlling, in order to set the growth period to be shorter or longer than the reference growth period, light source equipment of the plant factory such that an amount of light of the plant factory is greater or smaller than that during the reference growth period.

14. A condition presentation method comprising:
receiving, by a processor, conditions of a harvest time and a yield to be satisfied for a plant that is cultivated in a plant factory;
presenting, by the processor, at least one environmental control condition candidate that satisfies the conditions, together with a quality of the plant, based on environmental control condition information indicating an environmental control condition indicating a control condition of environmental control equipment that controls an environmental state in the plant factory, and a growth period and the yield of the plant, and the quality of the plant when the environmental control equipment controls the environmental state in the plant factory according to the environmental control condition; and
receiving, by the processor, a selection of the environmental control condition to be used for the control of the environmental state by the environmental control equipment of the plant factory, from the at least one environmental control condition candidate.

15. A non-transitory computer readable medium having recorded thereon a program for causing a computer to execute
receiving conditions of a harvest time and a yield to be satisfied for a plant that is cultivated in a plant factory;
presenting at least one environmental control condition candidate that satisfies the conditions, together with a quality of the plant, based on environmental control condition information indicating an environmental control condition indicating a control condition of environmental control equipment that controls an environmental state in the plant factory, and a growth period and the yield of the plant, and the quality of the plant when the environmental control equipment controls the environmental state in the plant factory according to the environmental control condition; and
receiving a selection of the environmental control condition to be used for the control of the environmental state by the environmental control equipment of the plant factory, from the at least one environmental control condition candidate.

16. The condition presentation apparatus according to claim 10, wherein the predetermined rate is determined in advance according to a market size of the plant and a maximum yield of the plant that is able to be cultivated in the plant factory.

17. The condition presentation apparatus according to claim 8, wherein the prediction server uses a learning model for each type of the plant to predict the predicted market price and the predicted amount of demand for each type of the plant.

18. The condition presentation apparatus according to claim 13, wherein the environmental control condition includes the control condition of at least one of the air conditioner or the blower fan included in the air conditioning equipment.

19. The condition presentation apparatus according to claim 13, wherein the environmental control condition includes the condition for controlling, in order to set the growth period to be shorter than the reference growth period, the air conditioning equipment such that the temperature is higher than that during the reference growth period.

20. The condition presentation apparatus according to claim 13, wherein the environmental control conditions includes the control condition for electric power, a current, or a voltage that is supplied to a dimmer included in the light source equipment.
